(19) United States
(12) Patent Application Publication
(10) Pub. No.: US 2026/0063763 A1
(43) Pub. Date: Mar. 5, 2026

(54) METHOD FOR TARGET DETECTION IN A DDM RADAR SENSOR

(71) Applicant: Robert Bosch GmbH, Stuttgart (DE)

(72) Inventors: Robert Prophet, Stuttgart (DE); Benedikt Loesch, Stuttgart (DE)

(21) Appl. No.: 19/294,845

(22) Filed: Aug. 8, 2025

(30) Foreign Application Priority Data
Aug. 29, 2024 (DE) 10 2024 208 229.5

(51) Int. Cl. G01S 7/41; G01S 13/44; G01S 13/58; G01S 13/931

(52) U.S. Cl. CPC G01S 7/415; G01S 7/418; G01S 13/449; G01S 13/582; G01S 13/931

(57) ABSTRACT

A method for target detection in a DDM radar sensor having a number N_{TX} of transmission antennas Tx and a number N_{Slots}>N_{TX} of DDM slots, the assignment of which to transmission antennas is determined by a DDM code. The method includes: calculating a range-Doppler matrix, which is divided in the Doppler dimension into N_{Slots} ambiguity zones; converting the range-Doppler matrix into a three-dimensional range-Doppler ambiguity matrix by converting the range-Doppler matrix into a three-dimensional range-Doppler ambiguity matrix by non-coherent cyclic discrete convolution with the DDM code; and target detection by cell-by-cell comparison of the range-Doppler ambiguity matrix (34) with a threshold matrix.

### CROSS REFERENCE

The present application claims the benefit under 35 U.S.C. § 119 of Germany Patent Application No. DE 10 2024 208 229.5 filed on Aug. 29, 2024, which is expressly incorporated herein by reference in its entirety.

### FIELD

The present invention relates to a method for target detection in a DDM radar sensor having a number N_{Tx} of transmission antennas and a number N_{Slots}>N_{Tx} of DDM slots, the assignment of which to transmission antennas is determined by a DDM code.

In particular, the present invention relates to a DDM (Doppler division multiplex) radar sensor that is used in driver assistance systems of motor vehicles or in autonomous driving systems for detecting the traffic environment.

### BACKGROUND INFORMATION

The plurality of transmission antennas of the radar sensor are spatially offset from one another, thus making angularly resolved localization of radar targets possible. Orthogonal transmission signals are supplied to the transmission antennas, so that a plurality of antennas can be active at the same time and nevertheless the signals transmitted by different antennas can be separated from one another at the receiving side. The transmission signals can consist of sequences of linear frequency modulated chirps. Distance information about the localized radar targets can then be obtained by mixing the received radar echo with a portion of the transmission signal, so that by beating a lower frequency signal is obtained, the frequency of which corresponds to the frequency difference between the transmitted and received signal. Since the frequency of the transmission signal increases linearly during a chirp, this frequency difference depends on the propagation time of the signal and thus on the distance of the radar target. If the radar target comprises a radial velocity other than zero relative to the radar sensor, an additional frequency shift results due to the Doppler effect, which, however, does not significantly distort the distance measurement if the ramp steepness of the chirps is sufficient. However, the Doppler shift causes the received signals to exhibit a certain phase progression from chirp to chirp, which allows the radial velocity of the target to be measured.

The DDM modulation method ensures the orthogonality of the transmitted signals and makes possible a long range of the radar sensor along with a high resolution in the velocity dimension at comparatively moderate costs. The DDM phase modulator comprises a phase shifter for each of the simultaneously active transmission antennas, which rotates the phase of the signal forwarded to the antenna so that the phase of the signal transmitted in the current chirp is rotated by a certain angle compared to the phase of the previous chirp, with this angle varying from antenna to antenna. This phase progression from chirp to chirp has the same effect on the received signal as the Doppler shift caused by the radar target's own movement. In this way, each transmission antenna is characterized by a characteristic “virtual” Doppler shift.

The range-Doppler matrix can be calculated using a two-dimensional Fourier transformation (FFT). In the range dimension (distance dimension), the Fourier integral runs over the sampling times within a single chirp. In the Doppler dimension (relative velocity dimension), the Fourier integral runs over the corresponding sampling times in the successive chirps. Each detected radar target is represented in the range-Doppler matrix by a peak in a cell of the range-Doppler matrix, which is defined in the distance dimension by the distance of the radar target and in the Doppler dimension by the relative velocity of the target. However, since in practice the sampling frequencies in both dimensions cannot be selected to be arbitrarily large, so-called undersampling often occurs, with the result that the distance and velocity information is not unambiguous. Due to the periodicity of the radar signals, the peaks in the Doppler dimension repeat at regular velocity intervals. If it is known from the outset that the possible velocity of the radar target lies within an interval that is smaller than the distance between the peaks, then an unambiguous velocity measurement is easily possible. However, if the possible velocities of the target are scattered over a larger range, the ambiguity must be resolved by special processes.

In a typical DDM radar, no phase shift takes place in one slot (which receives the slot index 0), while in another slot (which receives the index 1) the phase of the transmission signal is rotated from chirp to chirp by a phase angle

$$Δφ = \frac{360 °}{{N}_{Slots}} .$$

In the next slot, the phase shift from chirp to chirp is 2Δφ; in the slot with the index 3, it is 3Δφ, etc. Since the phase shift returns to 0 in the slot with index Nₛₗₒₜₛ, the smallest non-zero phase shift Δφ determines the number N_{Slots} of possible slots. Since these phase shifts simulate an additional Doppler shift, the unambiguous range in the velocity dimension is reduced by a factor of

$$\frac{1}{{N}_{slot}}$$

in a DDM radar. In general, this has the consequence that the unambiguous range is exceeded even with a relatively small possible variation in the actual velocities of the radar targets. If the number N_{TX} of the transmission antennas is smaller than N_{Slots}, the ambiguity can be resolved using conventional algorithms. Examples of such algorithms are described in Europe Patent Application Nos. EP 3 611 538 A1 and EP 4 009 074 A1, and U.S. Patent Application No. US 2021/132,187 A.

### SUMMARY

An object of the present invention is to provide a method that makes a better resolution of velocity ambiguities possible.

This object may be achieved according to an example embodiment of the present invention by a method having the following steps:
calculating a range-Doppler matrix, which is divided in the Doppler dimension into N_{Slots} ambiguity zones,
converting the range-Doppler matrix into a three-dimensional range-Doppler ambiguity matrix by non-coherent cyclic discrete convolution with the DDM code, and
target detection by cell-by-cell comparison of the range-Doppler ambiguity matrix with a threshold matrix.

According to an example embodiment of the present invention, the range-Doppler matrix is convolved cell-by-cell with a kernel that is given by the DDM code, but is periodically continued with a modulo function. With the special type of convolution operation, not only are the velocity ambiguities resolved, but the convolution kernel also averages the signals of the N_{TX} transmission antennas, as a result of which a non-coherent integration gain of approximately 7 log₁₀ N_{TX} dB arises, which results in a higher signal-to-noise ratio for target detection. A further advantage is that the detection step can also detect a plurality targets that exhibit the same ambiguous velocity.

Advantageous embodiments and developments of the present invention are disclosed herein.

In an advantageous embodiment, N_{Slots}≥2 N_{TX}.

The threshold matrix can be derived from a so-called noise floor matrix, which is obtained by averaging the N_{TS} smallest values of the cells across the ambiguity zones. In this way, not only is a useful measure of the noise background obtained, but due to the averaging, the noise signal also has the same non-coherent integration gain as the total signal. In a specific embodiment, the threshold matrix can also be determined directly from the range-Doppler matrix without averaging.

By definition, the autocorrelation function of the DDM code reaches its maximum at index s=0, but it also possesses sidelobes at other index values. These sidelobes reduce the signal distance between the range-Doppler ambiguity cell corresponding to the true velocity and the respective range-Doppler cells in other ambiguity bins, thereby complicating detection. However, for a given number N_{TX} of transmission antennas and a given number of slots N_{Slots}, it is possible, through systematic simulations, to find a DDM code in which the sidelobes in the autocorrelation function are largely suppressed.

Instead of using the range-Doppler ambiguity matrix directly for target detection, it is also possible to limit the ambiguity dimension to those bins in which genuinely stronger targets are located. In this way, the storage requirements can be reduced.

In one example embodiment of the method of the present invention, only those cells that are local maxima in the distance and Doppler dimensions are taken into account during the actual target detection. Since the range-Doppler ambiguity matrix specifies both the ambiguous velocity and the ambiguity range in which the true velocity of the target lies, the true velocity of the target can be determined, and with the DDM code, the relationship between occupied DDM slots (and the corresponding ambiguity zones in the range-Doppler matrix) and the associated transmission antennas is also known, so that unambiguous signal processing for angle estimation is possible.

In the case of a MIMO radar sensor with a plurality of reception antennas, it is understood that the steps described above are carried out for each reception channel, so that the different reception channels can also be taken into account when estimating the angle. The actual angle estimation can then be performed, for example, with the aid of a Fourier transformation on the basis of the processed location signal.

For a detected target, the vector of complex signals formed by the corresponding range-Doppler cells in the various N_{Slots} ambiguity zones can also be used as an input variable for an iterative CLEAN algorithm in order to separate the measurement data of superimposed targets and thus improve the dynamics with regard to targets having the same ambiguous velocity. Similarly, a CLEAN algorithm can also be used in angle estimation along the angle dimension in order to determine a plurality of target angles of targets with the same unambiguous velocity.

Alternatively, other multi-target estimation methods described in the literature can be used.

The present invention is explained in more detail below with reference to an exemplary embodiment.

### BRIEF DESCRIPTION OF THE DRAWINGS

FIG. 1 is a block diagram of a transmission part of a radar sensor with which the method according to an example embodiment of the present invention can be carried out.

FIG. 2 is a frequency/time diagram for a transmission signal.

FIG. 3 is a diagrammatic representation of phase progressions in a DDM radar.

FIG. 4 is a block diagram of an evaluation device configured for the method according to an example embodiment the present invention.

FIG. 5 shows an example of a DDM code.

FIG. 6 shows the autocorrelation function of the DDM code according to FIG. 5.

FIG. 7 is a diagram for illustrating the operation of a VAR solver shown in FIG. 4, which converts a range-Doppler matrix into a range-Doppler ambiguity matrix (RDVAR).

FIG. 8 is a diagram for illustrating a reduction of the RDVAR matrix to a region of interest.

FIG. 9 is a diagram for illustrating a function of the VAR solver, which converts the range-Doppler matrix into a noise floor matrix.

FIG. 10 is a flow chart that shows the steps of the method according to an example embodiment of the present invention.

### DETAILED DESCRIPTION OF EXAMPLE EMBODIMENTS

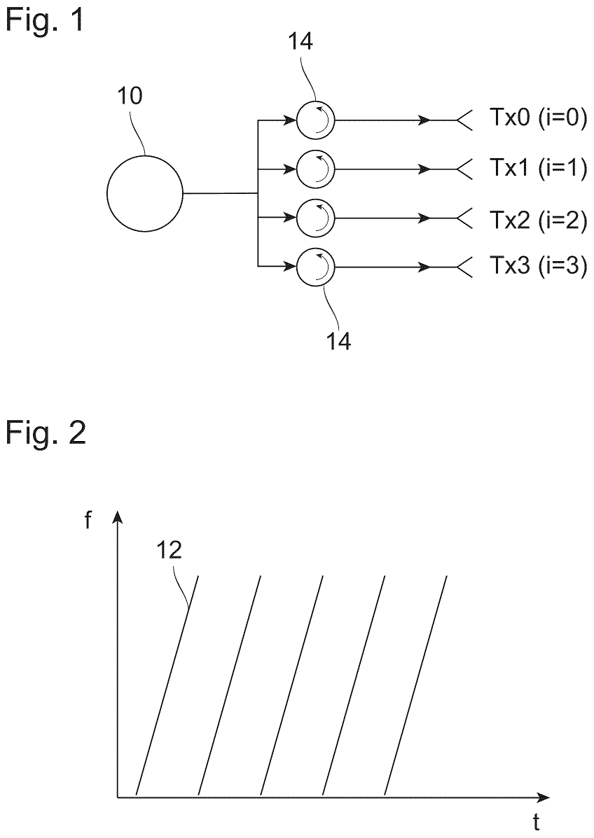

FIG. 1 shows schematically the transmission part of a radar sensor that comprises four transmission antennas Txi (0≤i≤3). Although not shown here, the radar sensor will usually be configured as a MIMO radar, which can be used to make angle estimations according to the MIMO (Multiple-Input Multiple-Output) principle. A signal generator 10 generates a transmission signal that has the frequency profile shown in FIG. 2. This signal consists of sequences, repeatedly transmitted at regular time intervals, of so-called chirps 12, in which the frequency f increases linearly as a function of time t. This transmission signal is supplied to the transmission antennas Txi via a phase shifter 14, which rotates the phase of the signal by a certain angle for each chirp. If p (0≤p≤3) is an index that counts the chirps 12 in the sequence, and i is the index that counts the transmission antennas, then the complex amplitude of the transmission signal in the chirp p in the antenna i can, for example, have the following form:

$$A ( t ) = a exp ( j ω ( t ) t + {φ}_{p , i} )$$

Here, a is a real constant, j is the imaginary unit, ω(t) is the (circular) frequency dependent on time t, and φ_{p,i} is a phase angle. The phase shifters 14 can be controlled so that they set the phase angle φ_{p,i}, for example according to the following formula:

$${φ}_{p , i} = ( 2 π / {N}_{Tx} ) * p * i$$

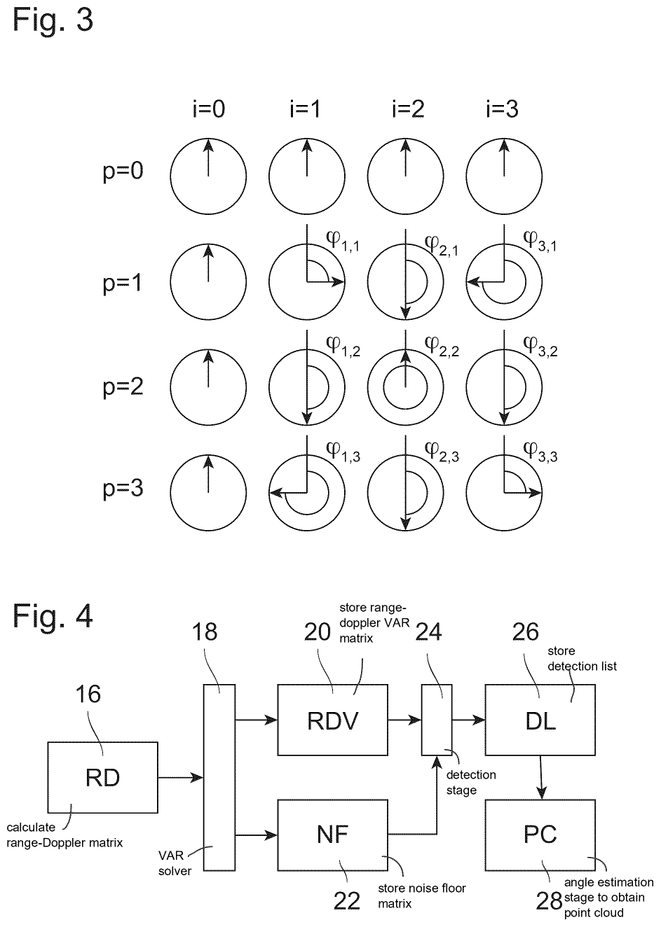

In FIG. 3, the phase angles φ_{p,i} of the signals for a conventional DDM radar with four antennas are shown. For antenna i=0, φ_{p,0} is equal to zero for all four chirps. For antenna i=1, the phase angle is zero for the first chirp and is then increased by 90° for each subsequent chirp. For antenna i=2, the phase angle is increased by 180° from chirp to chirp, starting with the phase angle φ_{0,2}=0. For antenna i=3, the phase angle is increased by 270° from chirp to chirp, likewise starting with φ_{0,3}=⁰ for the first chirp.

FIG. 4 is a block diagram of components of an evaluation system of the radar sensor. In a first evaluation stage 16, a range-Doppler matrix is calculated in each measurement cycle and in each reception channel by carrying out a two-dimensional Fourier transformation on a baseband signal obtained by down-mixing the reception signal. Each cell in the range-Doppler matrix is part of a distance bin (row of the matrix) and a Doppler bin (column of the matrix), and the signal value of the cell indicates the strength of the signal obtained from a radar target whose distance and radial relative velocity lie in the distance bin and the Doppler bin. A so-called VAR solver 18 converts the range-Doppler matrix into a range-Doppler VAR matrix, which is temporarily stored in a memory 20. The abbreviation VAR stands for Velocity Ambiguity Range and refers to an ambiguity range composed of a plurality of adjacent columns in the range-Doppler matrix, as will be explained in more detail later. The German term for “range-Doppler VAR matrix” is therefore Range-Doppler-Mehrdeutigkeits-Matrix [“range-Doppler ambiguity matrix” in English].

Furthermore, the VAR solver 18 converts the range-Doppler matrix into a so-called noise floor matrix, which is stored in a further memory 22. This matrix indicates, in a sense, the noise background from which the signals stored in the range-Doppler VAR matrix are to stand out.

In a detection stage 24, radar targets are detected by comparing the cell contents of the range-Doppler VAR matrix with a threshold matrix, which can be the noise floor matrix itself or a threshold matrix that has been derived from the noise floor matrix using conventional methods, for example the CFAR (Constant False Alarm Rate) method. Alternatively, the threshold matrix could also be ascertained directly from the range-Doppler matrix using conventional methods. Prior to the actual detection, a coherent summation (e.g., with the aid of an angle FFT) or non-coherent summation of the range-Doppler spectra of the individual reception channels is performed prior to detection.

The result of the detection step is a detection list that is stored in a further memory 26 and contains the location signals of all localized radar targets.

The detection list is then supplied to an angle estimation stage 28, where an angle estimation is performed using conventional methods in order to obtain a point cloud that characterizes the current environment of the radar sensor.

Each of the phase shifters 14 shown in FIG. 1 defines a DDM slot that is characterized by the phase progression in the transmission channel in question. The smallest non-zero phase progression determines the number N_{Slot} of the total available slots according to the formula

$${N}_{Slot} = \frac{360 °}{{φ}_{1 , 1}} .$$

In the example shown in FIG. 3, φ_{1,1}=90°, and accordingly, N_{Slot}=4. In this example, N_{Slot} thus corresponds to the number N_{TX} of simultaneously active transmission antennas.

However, in order to make the resolution of velocity ambiguities possible, phase progressions are used in practice where N_{Slot} is greater than N_{TX}, preferably at least twice as large. In this case, some slots remain unoccupied because there are not enough transmission antennas. The slots occupied by transmission antennas are specified by the so-called DDM code. This is a binary vector with the components dₛ, (s=0, . . . , (N_{Slot}−1)). In FIG. 5, the DDM code

$$d = ( 1 , 1 , 0 , 1 , 0 , 0 , 0 , 1 , 1 , 0 , 0 , 0 , 0 , 1 , 0 , 0 )$$

is graphically shown as an example. In this example, N_{Slots}=16 and N_{TX}=6, so that only six slots are occupied by antennas.

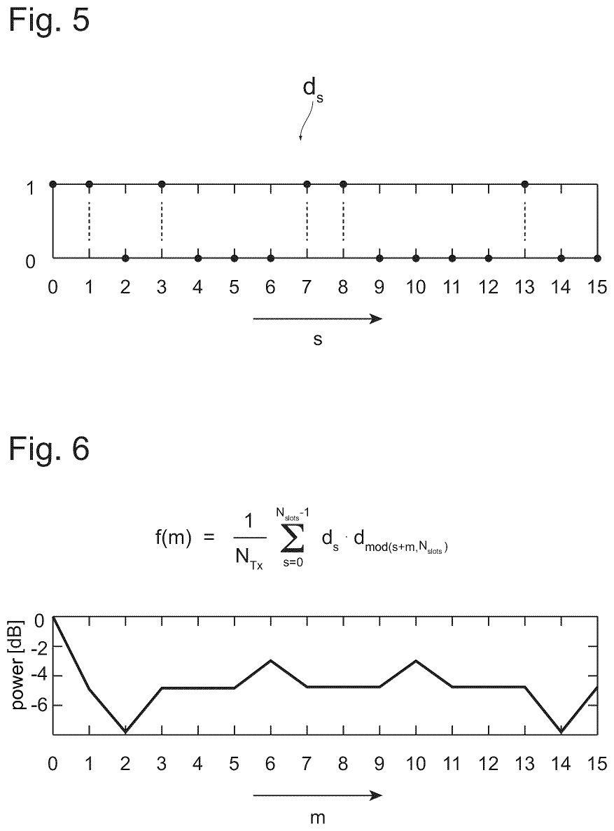

FIG. 6 shows the corresponding autocorrelation function ƒ(m). The variable m is an index that counts ambiguity zones (also called spectrum slots) in the range-Doppler matrix. If the DDM code, whose components are designated here by the index i, is considered as a function d(s), then f(m) is the result of a convolution of the function d(s) with a kernel which, in turn, is defined by the DDM code d, but is periodically continued using a modulo function. The index of the second d in the formula in FIG. 6 has the meaning: (s+m)modulo N_{Slots}.

At m≠0, the correlation function ƒ(m) has a maximum by definition. The sum in the specified formula is then simply equal to the number N_{TX} of the non-zero components of the DDM code, so that normalization yields the value 1 or 0 dB. However, the correlation function exhibits more or less pronounced sidelobes at non-zero values of m. For example, for m=6:

$$\begin{matrix}{NT}_{x} f ( 6 ) = {d}_{0} + {d}_{6} + {d}_{1} + {d}_{7} + {d}_{3} + {d}_{9} + {d}_{7} + {d}_{13} + {d}_{8} + {d}_{14} + {d}_{13} + {d}_{3} \\ = 0 + 1 + 0 + 1 + 0 + 1 \\ = 4\end{matrix}$$

The component d₃ in the last summand results from the modulo function.

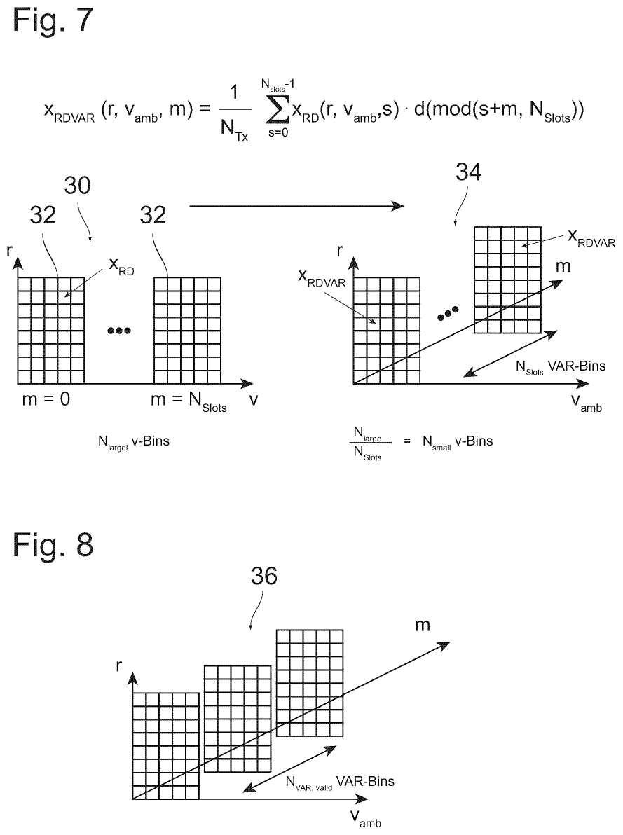

An example of a range-Doppler matrix is shown graphically in FIG. 7. In this simplified example, the matrix has eight cells or bins in the range dimension r, and in the Doppler dimension v the number of bins is N_{large}. If the transmission signals were not phase-modulated, the range-Doppler matrix in the Doppler dimension would cover the entire range of velocities that could theoretically occur (for example, in a radar for cars, −150 km/h to +150 km/h), and the sampling frequency would be so high that the distance measurement within this range would be unambiguous. However, the phase modulation induces N_{Slots} different synthetic Doppler shifts, with the result that even at a relative velocity v=0, the Doppler spectrum would not just obtain a single peak, but rather one peak for each DDM slot. Therefore, the range-Doppler matrix is divided in the Doppler dimension into a number N_{Slots} of ambiguity zones 32, which are also referred to as spectrum slots and are counted here by the index m, which also appears in FIG. 6. The number of Doppler cells or v bins within each ambiguity zone is therefore N_{Small}=N_{Large}/N_{Slots}. Each matrix cell contains an entry x_{RD} that indicates the signal strength of a radar target, whose distance and velocity are determined by the position of the cell within the matrix.

One function of the VAR solver 18 is to convert, according to the formula given in FIG. 7, the two-dimensional range-Doppler matrix 30 into a three-dimensional range-Doppler VAR matrix 34, which is graphically shown on the right-hand side in FIG. 7. The third dimension here is the dimension in which the ambiguity index m varies. In the velocity dimension v_{amb}, this matrix has only N_{Small} cells. The index “amb” in V_{amb} indicates that the velocity in this dimension is ambiguous, since the true velocity of the target could lie in any of the N_{Slots} bins in the ambiguity dimension m. The relationship between the velocity v in the matrix 30 and the velocity v_{amb} in the matrix 34 is given by:

$$v = {v}_{amb} + m {v}_{small}$$

where vₛₘₐₗₗ is the width of a single ambiguity zone 32.

The entry x_{RDVAR} in each matrix cell of the three-dimensional matrix 34 is a function of the distance r, the velocity v_{amb} and the ambiguity index m. The entries x_{RD} in the two-dimensional matrix 30 can also be regarded as functions of these three variables, but in the formula in FIG. 7 the index m is replaced by the summation index s.

According to the formula indicated in FIG. 7, the VAR solver 18 carries out a non-coherent discrete convolution on the functions x_{RD} (r, v_{amb}, s) with the kernel d (mod(s+m, M_{Slots})) from FIG. 6.

Through this convolution, the different ambiguity zones 32 are correlated with one another, so that in the three-dimensional matrix 34 a maximum is obtained where the correlation is greatest. As a result, this not only resolves the velocity ambiguities, but also results in an integration gain due to the summation over the index s.

In the three-dimensional range-Doppler VAR matrix 34 in FIG. 7, the number of VAR bins in the VAR dimension m is N_{Slots}. In practice, however, it will often be the case that none of these VAR bins contains a significant signal at any point, i.e., for any combination of r and v_{amb}. In order to reduce the storage requirements and the computational effort, it is therefore useful to “thin out” the matrix by limiting oneself to those bins in which a significant signal is actually present. This is symbolized in FIG. 8 by replacing the matrix 34 with a three-dimensional RoI matrix 36 (range of interest). The number of VAR bins in this matrix is reduced to N_{VAR,valid}.

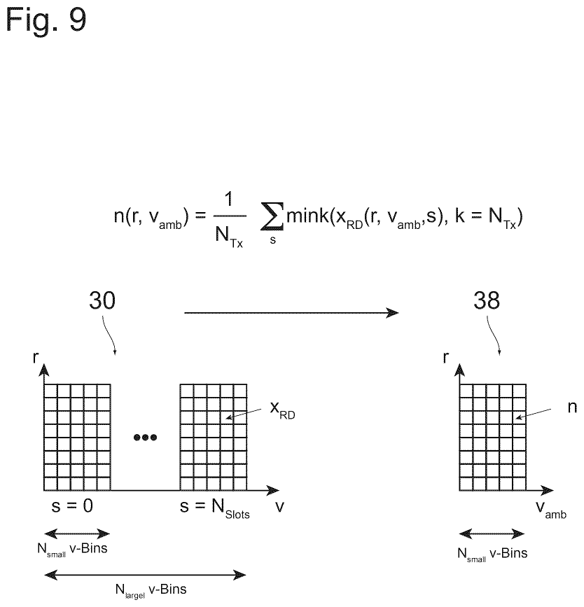

A further function of the VAR correlator 18 is to calculate, based on the two-dimensional range-Doppler matrix 30, a likewise two-dimensional noise floor matrix 38, which, in the velocity dimension v_{amb}, has only Nₛₘₐₗₗ v bins, just like the range-Doppler VAR matrix 34, as shown in FIG. 9. The entries m in the noise floor matrix 38 indicate a noise background for each cell and are calculated according to the formula specified in FIG. 9. The function “mink” is used to identify the cells in the range-Doppler matrix 30 that contain the N_{Tx} smallest entries, and in the ambiguity dimension s these entries are averaged. Due to the averaging, the integration gain mentioned above is again achieved here.

For target detection, either the noise floor matrix 38 can be used directly as the threshold matrix or a suitable threshold matrix can be calculated from this matrix using conventional methods, for example the CFAR method.

Alternatively, the threshold matrix could also be ascertained directly from the range-Doppler matrix using conventional methods.

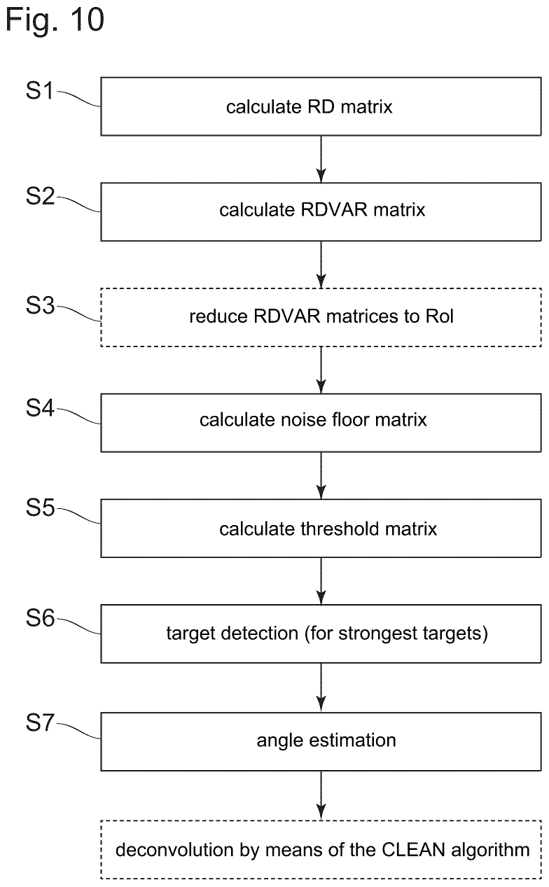

In FIG. 10, the steps of the method are summarized in a flow chart. In step S1, a range-Doppler matrix is calculated for each reception channel. In step S2, a range-Doppler VAR matrix (range-Doppler ambiguity matrix) is calculated with the aid of the VAR solver 18. In an optional step S3, the matrix calculated in step S2 is reduced to a RoI matrix 36. In step S4, the noise floor matrix 38 is then calculated with the aid of the VAR solver 18, from which a threshold matrix is then formed in step S5, for example by simply adopting the noise floor matrix as the threshold matrix. In step S6, the target detection is then carried out with the aid of the detection stage 24 in FIG. 4. For this purpose, the entries in the RoI matrix are compared with the entries in the threshold matrix. According to a variant of the method, only those cells are taken into account that represent local maxima in relation to the dimensions of distance and unambiguous velocity. A significant advantage of the method proposed here is that in this way, targets having the same ambiguous velocity v_{amb} can also be detected in the detection step.

In step S7, an angle estimation is then carried out using conventional methods. The location signals are processed so that they are comparable with one another with regard to angle estimation.

In an optional step S8, conventional iterative CLEAN algorithms can then be used to further process the data that were subjected to a convolution operation in step S2, so that targets with the same ambiguous velocity can be better distinguished and characterized. The CLEAN algorithm can be used not only in the ambiguity dimension, but also in the angle dimension in order to determine a plurality of target angles of targets with the same unambiguous velocity.

The sequence of the proposed iterative range-Doppler CLEAN method can be outlined as follows: After successful estimation of a first ambiguity region and the corresponding target angle(s), the complex location signal (i.e., the complex amplitudes of the transmission and reception channels) of these radar targets is calculated. The location signal is then coherently received by those cells of the N_{Slots} large input vector of the range-Doppler matrix that are occupied by the radar targets according to their ambiguity range, before a further iteration can begin. In the next iteration, in turn a determination of the ambiguity region is carried out with the aid of the DDM code and the formula from FIG. 7. By previously subtracting the signal components of the already detected targets, a weaker target can now also be detected. The detection process is again carried out according to FIGS. 4, 7, 8 and 9.

As soon as a termination criterion is fulfilled, e.g., an insufficient amplitude of the remaining location signal, the CLEAN algorithm ends. In the case of high-quality angle estimation, dynamics of over 30 dB or even over 40 dB can be achieved.

Alternatively, another multi-target estimation algorithm such as RELAX can be used instead of the CLEAN algorithm.

What is claimed is:

1. A method for target detection in a DDM radar sensor having a number N_{TX} of transmission antennas Tx and a number N_{Slots}>N_{TX} of DDM slots, an assignment of which to the transmission antennas is determined by a DDM code, the method comprising the following steps:
calculating a range-Doppler matrix, which is divided in a Doppler dimension into N_{Slots} ambiguity zones;
converting the range-Doppler matrix into a three-dimensional range-Doppler ambiguity matrix by non-coherent cyclic discrete convolution with the DDM code; and
performing target detection by cell-by-cell comparison of the range-Doppler ambiguity matrix with a threshold matrix.

2. The method according to claim 1, in which N_{Slots}≥2 N_{Tx}.

3. The method according to claim 1, wherein the threshold matrix is derived from a noise floor matrix, which is calculated based on the range-Doppler matrix by averaging, in each range-Doppler bin, N_{Tx} smallest entries of the matrix cells across the ambiguity zones.

4. The method according to claim 1, wherein, for determination of a convolution kernel, the DDM code is selected, which dampens expression of sidelobes in an autocorrelation function.

5. The method according to claim 1, wherein those ambiguity bins in which a certain minimum signal strength is achieved in at least one range-Doppler cell, and in which the target detection is carried out on a RoI matrix that contains only selected ambiguity bins, are selected from the range-Doppler ambiguity matrix.

6. The method according to claim 1, wherein only those matrix cells which are local maxima in a distance dimension and the Doppler dimension are taken into account during target detection.

7. The method according to claim 1, for the target detection in distance and velocity, an angle estimation is performed based on data received in a plurality of reception channels.

8. The method according to claim 1, in which a multi-target estimation algorithm is used to more sharply separate targets with a same ambiguous velocity from one another.

9. The method according to claim 8, wherein the multi-target estimation algorithm is used to determine a plurality of target angles of targets with the same unambiguous velocity.

10. A radar system for target detection, the radar system comprising a DDM radar sensor having a number N_{Tx} of transmission antennas Tx and a number N_{Slots}>N_{Tx} of DDM slots, an assignment of which to the transmission antennas is determined by a DDM code, the radar system being configured to:
calculate a range-Doppler matrix, which is divided in a Doppler dimension into N_{Slots} ambiguity zones;
convert the range-Doppler matrix into a three-dimensional range-Doppler ambiguity matrix by non-coherent cyclic discrete convolution with the DDM code; and
perform target detection by cell-by-cell comparison of the range-Doppler ambiguity matrix with a threshold matrix.
